(19) United States
(12) Patent Application Publication
(10) Pub. No.: US 2026/0108947 A1
(43) Pub. Date: Apr. 23, 2026

(54) Isostatic pressing on LOM-assembled metal parts

(71) Applicant: Alloy Enterprises Inc., Burlington, MA (US)

(72) Inventors: Steve Onorato, Woburn, MA (US); Kevin Simon, Cambridge, MA (US); Paul Titchener, Somerville, MA (US); Lyle Cheatham, Marblehead, MA (US); Alan Lai, Cambridge, MA (US); Ellen Benn, Boston, MA (US)

(21) Appl. No.: 19/168,708

(22) PCT Filed: Mar. 30, 2024
(86) PCT No.: PCT/US2024/022426

§ 371 Date: Sep. 24, 2025

Related U.S. Application Data
(60) Provisional application No. 63/493,041, filed on Mar. 30, 2023.

(51) Int. Cl. B22F 10/66; B22F 5/10; B33Y 10/00; B33Y 30/00; B33Y 40/20

(52) U.S. Cl. CPC B22F 10/66; B22F 5/10; B33Y 10/00; B33Y 30/00; B33Y 40/20

(57) ABSTRACT

Methods and systems for the additive manufacturing of metal parts. Some embodiments include a method that includes depositing a plurality of foil layers, the plurality of foil layers comprising at least one void space and forming a workpiece having an object region and a support region, the support region connected to the object region and the void space being fluidically isolated from the exterior of the workpiece; and applying pressure to the workpiece to collapse the at least one void space.

### CROSS-REFERENCE TO RELATED APPLICATIONS

The present application claims the benefit of and priority to U.S. Provisional Application No. 63/493,041, filed on Mar. 30, 2023, the entire disclosure of which is hereby incorporated by reference as if set forth in its entirety herein.

### TECHNICAL FIELD

Embodiments described herein generally relate to methods and apparatus for fabricating metal laminated object parts, and more specifically to the application of isostatic pressing to metal laminated object parts in the course of fabrication.

### BACKGROUND

In traditional additive manufacturing methods such as laminated object manufacturing (LOM), assembling complex 3D structures involves sequentially adding layers of material to a structure. Each successive layer is bonded to and/or deposited on the previous layer to gradually assemble the 3D structure. Often these layers are cut or shaped prior to being incorporated into the part. The layers may include a wide variety of materials, including various metals.

In many scenarios, metal parts assembled via additive manufacturing methods may be encased within support structures. Extracting the parts from the support structures may be a difficult and laborious task in traditional additive manufacturing processes depending on the geometries of the parts and how the parts interface with the support structures. Support structures that support overhangs or partially enclosed volumes within the parts may be difficult to remove without additional design rules and features on the part that allow access to the internal volume. Additionally, separate post-processing steps for part extraction, heat treatment, and part strengthening through isostatic pressing may increase overall processing time and labor costs.

Accordingly, a need exists for improved methods and systems of additive manufacturing of metal parts.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a method for manufacturing an object. The method includes depositing material sequentially to form a workpiece, the material configured to comprise at least one part region, at least one support structure region, and at least one collapsible void space; and isostatically pressing the workpiece to collapse the collapsible void space.

In some embodiments, the workpiece is formed by depositing a plurality of foil layers to form a layered workpiece.

In some embodiments, the collapsible void space is fluidically isolated.

In some embodiments, collapsing the collapsible void space separates at least one part region from at least one support structure region.

In some embodiments, collapsing the collapsible void space separates at least one support structure region from at least one other support structure region.

In some embodiments, at least one part region is connected to at least one support structure region.

In some embodiments, the collapsible void space is configured in a part region to form at least one of a fold line and fold curve, such that collapsing the collapsible void space changes the geometry of the workpiece.

In some embodiments, the collapsible void space is distributed throughout at least one of the part region and the support structure region. In some embodiments, the collapsible void space is configured in a way that reduces the size of at least one of the part region and the support structure region to less than the size of an aperture on an enclosure formed by at least one of the complementary regions.

In some embodiments, the collapsible void space is vertically separated by at minimum one foil layer thickness.

In some embodiments, the collapsible void space is configured to have an aspect ratio greater than 1 and the long dimension of the collapsible void space is parallel to an axis of force applied to the workpiece.

In some embodiments, the collapsible void space has a cross-sectional geometry that is rectilinear, triangular circular, or ellipsoid.

In some embodiments, the collapsible void space is configured to transmit force applied perpendicular to the layers with minimal stress non-uniformities.

In some embodiments, the collapsible void space comprises a percent void space of at most 55% of the geometric volume of at least one of the part and support structure regions.

In another aspect, embodiments relate to a system for additive manufacturing of an object. The system includes an additive manufacturing device configured to deposit material sequentially to form a workpiece, the material configured to comprise at least one part region, at least one support structure region, and a collapsible void space; and a pressor configured to isostatically press the workpiece to collapse the collapsible void space.

In some embodiments, the workpiece is formed from a bonded stack of foil layers.

In some embodiments, the collapsible void space is fluidically isolated.

In some embodiments, collapsing the collapsible void space separates at least one part region from at least one support structure region.

In some embodiments, at least one part region is connected to at least one support structure region.

In some embodiments, the pressor is configured to submerge the workpiece in a fluid and apply pressure to the workpiece through the fluid.

### BRIEF DESCRIPTION OF DRAWINGS

Non-limiting and non-exhaustive embodiments of this disclosure are described with reference to the following figures, wherein like reference numerals refer to like parts throughout the various views unless otherwise specified:

FIG. 1 depicts a top-down cross section of a metal sheet for assembling a workpiece;

FIG. 2 depicts an embodiment of the metal sheet of FIG. 1 with additional features;

FIG. 3 depicts the metal sheet of FIG. 2 after the metal sheet has been isostatically pressed;

FIG. 4 depicts a top-down cross section of a different metal sheet;

FIG. 5 depicts the metal sheet of FIG. 4 after the metal sheet has been isostatically pressed;

FIG. 6 depicts a side-view cross section of a workpiece before isostatic pressing;

FIG. 7 depicts the workpiece of FIG. 6 after isostatic pressing;

FIG. 8 depicts a side-view cross section of another workpiece before isostatic pressing;

FIG. 9 depicts the workpiece of FIG. 8 after isostatic pressing;

FIG. 10 depicts a side-view cross section of yet another workpiece before isostatic pressing;

FIG. 11 depicts the workpiece of FIG. 10 after isostatic pressing;

FIG. 12 depicts a side-view cross section of still another workpiece before isostatic pressing;

FIG. 13 depicts the workpiece of FIG. 12 after isostatic pressing;

FIG. 14 depicts a side-view cross section of a part;

FIG. 15 depicts a side-view cross section of a part before isostatic pressing; and

FIG. 16 depicts the part of FIG. 15 after isostatic pressing.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

### Definitions

Unless otherwise specified, the following terms as used herein shall have the meanings as provided below:
The term “workpiece” refers to a stack of metal sheets to be bonded into at least one part and at least one corresponding support structure.
The term “metal sheet” refers to a metal sheet or foil that is stacked in the workpiece. Each metal sheet may be patterned to contain part regions and support structure regions. In some embodiments, the metal sheet may comprise at least one of aluminum, copper, magnesium, titanium, aluminum alloy, magnesium alloy, and/or titanium alloy.
The term “sheet” refers generally to a metallic layer between 25 μm to 10 cm in thickness.
The term “tab” refers to a bridge or other small portion of material on at least one metal sheet, which connects at least one region to a second region. A tab may be an uncut area on a metal sheet.
The term “void” refers to a volume cut out of a metal sheet in the support or part region which is fully enclosed and not fluidically connected to any other internal channel or port within the workpiece.
The term “void space” refers to a pattern of voids intentionally cut in a given volume or region which are later affected by the isostatic pressing process.
The term “percent void space” refers to a mathematical representation of void space, calculated by the ratio of the volume of void space in a region divided by the total enclosed volume of the same region.
The term “internal channel” refers to a volume cut out of a metal sheet either within the support structure region or between the support structure and part regions which may be fluidically connected to other internal channels or ports within the workpiece.
The term “gap” refers to the void space between two regions, which may be optionally fluidically connected to other internal channels and ports within the workpiece.

### EMBODIMENTS

Embodiments of the invention include methods and systems for applying isostatic pressing to LOM-assembled metal parts. These methods and systems may include the introduction of voids in at least one of the support structure and part regions prior to assembly into a workpiece. The workpiece, either during or after bonding, may then be subjected to isostatic pressing. Additional embodiments may include the application of hot or cold isostatic pressing on a workpiece with voids in the support structure to implode and remove portions of the support structure. Embodiments may include imploding or otherwise fracturing the support structure in a fashion that facilitates its removal from complex geometries on the part. Embodiments involving isostatic pressing may also include folding or other geometric translations of the part or support structure. Further details on these embodiments are discussed below.

### Workpieces

In some embodiments, a workpiece may consist of at least one part enclosed in at least one support structure. The workpiece may be assembled in a laminated fashion with a plurality of metal sheets patterned into support regions and part regions. In this manner, the workpiece may be a layered workpiece assembled by depositing a plurality of metal sheets. Some metal sheets may only consist of one type of region, such as support regions. Additional channels and/or voids may be cut into the support and part regions of the metal sheets, with the distribution of voids in a pattern which facilitates the isostatic pressing schemes described below. The metal sheets, after patterning, may be stacked together to form a workpiece. The workpiece may be bonded in a heated press, a more complicated bonding machine comprising a heated press and a vacuum chamber, and/or a bonding machine of any configuration appropriate for laminated object manufacturing of metal parts.

In some embodiments, workpieces may have additional volumes cut out of constituent metal sheets corresponding to internal channels which may be fluidically connected to other internal channels and/or ports on the workpiece. The internal channels may separate a part region from a support region and/or be cut through support regions.

In some embodiments, the workpiece may have additional volumes cut out of constituent metal sheets corresponding to voids in desired support structures and/or part regions to enable the isostatic pressing embodiments described below. These voids may be fluidically disconnected from other internal channels and/or voids in the workpiece. The volume of void space measured against the total geometric volume of the part or support region may be termed “percent void space,” which is a parameter used to guide isostatic pressing processes. In some embodiments, the percent void space may comprise a minority of the geometric volume of the support structure and/or part regions. For example, the percent void space may comprise an infinitesimal fraction of the total geometric volume and be concentrated in particular areas of the support structure. In some embodiments, the percent void space may comprise the majority of the geometric volume of the support structure and/or part regions.

In some embodiments, the void space may consist of a uniform, semi-uniform, and/or regular distribution of small, closed cell voids. In some embodiments, the void space may consist of a uniform, semi-uniform, and/or regular distribution of microscopic voids. The minimum size of the microscopic voids may be determined by the layer thickness and at least one of the kerf width and the pierce diameter of the cutting device used to cut the void sheet. The metal sheets may comprise roughened, textured, and/or patterned surfaces to form the microscopic voids. The voids may have any type of geometry within a top-down and/or side-view cross section, such as rectilinear, circular, cylindrical, ellipsoid, triangular, polygonal, and/or elongated. In some embodiments, void spaces may be vertically and/or horizontally separated by at least one metal sheet thickness. In some embodiments, the voids may be vertically and/or horizontally separated by at least twice the kerf width of the cutting device used to cut the voids. In other embodiments, the minimum volume of a void may be 1 mm³. In some embodiments, larger void spaces with a high aspect ratio (e.g., a ratio greater than 1) may be placed with a particular orientation (e.g., a parallel or perpendicular orientation) to the support or part region surface and/or the axis of force applied to the workpiece. For example, the long dimension of the void space may be parallel to the axis of force applied to the workpiece. Voids with a high aspect ratio may be co-located with tabs or other features of the support or part regions. Voids may be configured to follow a conformal surface either within at least one of the part or support structure region, or may be concentrated along the boundary of at least one of the part or support structure region. In embodiments with closed cell void space, the percent void space may comprise at most 55% of the geometric volume of the support structure and/or part regions.

In some embodiments, the void space may consist of a large open-cell void that is fluidically connected throughout the void space but has a continuous barrier to separate it from the part or support structure region. In some embodiments, the void space may be formed from regular, repeating geometric patterns, such as but not limited to gyroid, diamond, and lidinoid infill patterns. The geometric pattern in the void space may be a triply-periodic minimal surface (TPMS) structure, such as but not limited to a gyroid, diamond, lidinoid, neovius, or Schwarz pattern. In other embodiments, the void space may be formed from cutting connections between closed cell geometries to form a linked open cell network. The open cell void may be configured to follow a conformal surface either within at least one of the part or support structure region, or along the boundary of at least one of the part or support structure region. In embodiments with open cell void space, the percent void space may comprise at most 75% the geometric volume of the support and/or part regions.

In some embodiments, the shape of the voids and/or the distribution of void space may be configured to transmit force in one uniaxial direction (e.g., perpendicular and/or parallel to the metal sheets) and compress under applied pressure in other directions. The even transmission of force across the volume of the workpiece results in a uniform stress locally experienced by each sub-region of the workpiece. The uneven distribution of stress from the transmitted force may be termed “stress non-uniformity.” In some embodiments, the shape of the voids and/or the distribution of void space may be configured to transmit force (e.g., perpendicular to the metal sheets) with minimal (e.g., less than a threshold) stress non-uniformity. The threshold value for non-uniformity is a function of the material composition and thermal profile the workpiece is subjected to. The geometry and distribution of void spaces may be configured to transmit at least a minimum applied stress to all sub-regions of at least the part or support structure region, and at most a defined maximum stress beyond which the workpiece may deform. In some embodiments, stress non-uniformity is minimized preferentially in the part region of a workpiece. In some embodiments, the shape and distribution of void space may be configured to transmit force under one magnitude of applied pressure but yield under a greater magnitude of applied pressure.

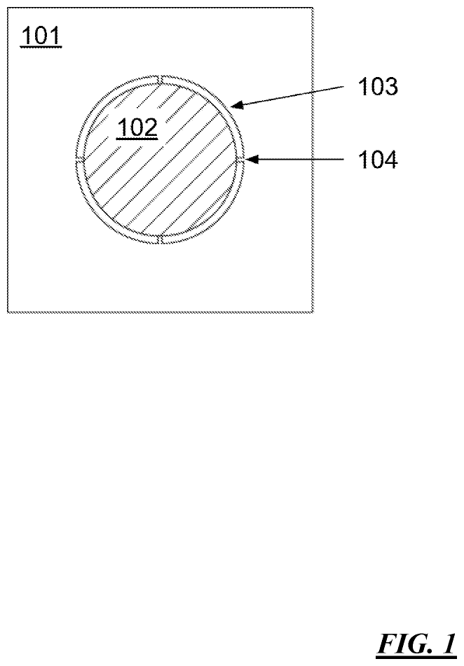

FIG. 1 depicts a top-down cross section of a metal sheet for assembling a workpiece. As shown, the metal sheet may comprise a support region 101 and a part region 102. The support and part regions may be separated by a gap 103. The support region 101 and the part region 102 may be connected by at least one tab 104. A workpiece may be assembled from multiple metal sheets of the type depicted to form a support structure, a part, and/or an internal channel separating the two regions.

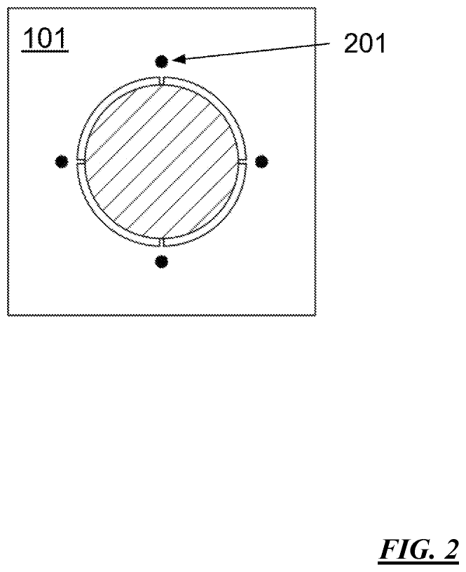

FIG. 2 depicts an embodiment of the metal sheet of FIG. 1 with additional features. Within the support region 101, additional cuts may be made to remove material close to the tabs, creating a void space 201 behind each tab. The void space 201 may be configured to transmit force perpendicular to the top-down cross section, the top-down direction being the axis of force application. A workpiece assembled from any number of sheets depicted in FIG. 2 with the top and bottom layers comprised of the sheets depicted in FIG. 1 may result in a workpiece containing at least one support structure, at least one part, at least one internal channel that is fluidically connected to the exterior, and/or at least one void space that is not fluidically connected to the exterior.

### Isostatic Pressing & Tab Fracturing

In some embodiments, a workpiece with support structures (e.g., a workpiece assembled by the sheets depicted in FIGS. 1 and 2) may be subjected to isostatic pressing. Some portion of the support structures of the workpiece may be removed from the workpiece prior to the isostatic pressing step. The workpiece may be placed in an isostatic pressing machine, and at least the internal channels in the workpiece may be filled with and/or otherwise submerged in a working fluid. In some embodiments, the workpiece may be immersed in the working fluid. The working fluid may be at least one of a mineral oil, hydraulic oil, high-purity argon, high-purity nitrogen, aqueous glycol mixture, aqueous solution, and/or another fluid. The working fluid may optionally be heated to a desired temperature. The isostatic pressing machine may be configured to increase the fluid pressure in the internal channels so that void spaces within the workpiece are compressed.

In some embodiments, the working fluid may be pressured prior to the optional heating step and/or the fluid may be heated prior to the pressurization step. Alternatively, a series of heating and pressurization steps may be applied sequentially to bring the workpiece to the final isostatic pressing process conditions.

In some embodiments, the workpiece may be subjected to isostatic pressing during a bonding process (e.g., by a heating press). In some embodiments, the workpiece may be subjected to isostatic pressing after the bonding process is complete. In some embodiments, the workpiece may be subjected to isostatic pressing after the bonding and heat treatment processes are complete.

In some embodiments, isostatic pressing may be used to fracture tabs connecting at least one first region of a workpiece to a second region of the workpiece. Both the first and second regions may consist of part and/or support regions. For example, the tab may connect a part region to a support region, a support region to a second support region, and/or a part region to a second part region. The voids may be concentrated behind tabs on at least one of the support and part regions.

In some embodiments, at least one void space and/or a pattern of void spaces may be placed behind a tab on the support region. In some embodiments, the wall of the void closest to the tab may be placed at least 1.0-1.5 mm from the base of the tab. The tab may connect the part region to the support region. Under isostatic pressing, the void spaces may compress, which may fracture the tab and separate the part from the support structure.

In some embodiments, a single tab may comprise multiple metal sheets. Void spaces within the workpiece may comprise a portion of the volume of a multi-sheet tab. A multi-sheet tab will have at least one contiguous sheet on all faces of the tab to enclose the void.

In some embodiments, at least one void space and/or a pattern of void spaces may be concentrated behind a tab on a support region that connects the support region to another support region. In some embodiments, the wall of the void closest to the tab may be placed at least 1.0-1.5 mm from the base of the tab. Under isostatic pressing, the voids may compress and fracture the tab between the support regions.

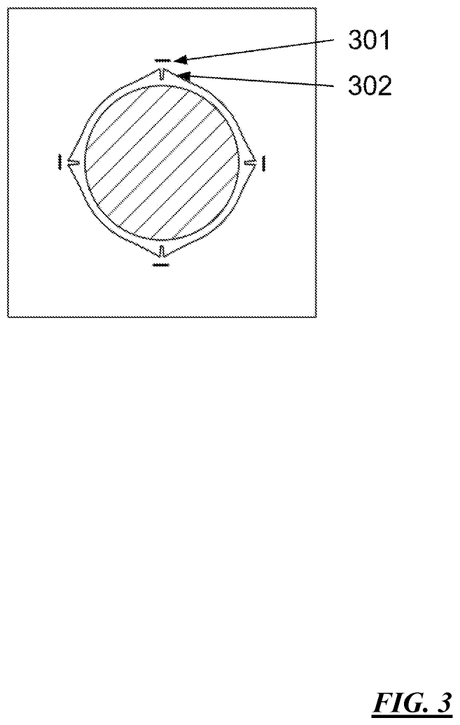

FIG. 3 depicts the metal sheet of FIG. 2 after the metal sheet has been isostatically pressed as part of a larger workpiece. As shown, the void spaces 301 within the metal sheet may compress during the isostatic pressing process, which may cause the tabs 302 bridging the support and part regions to fracture.

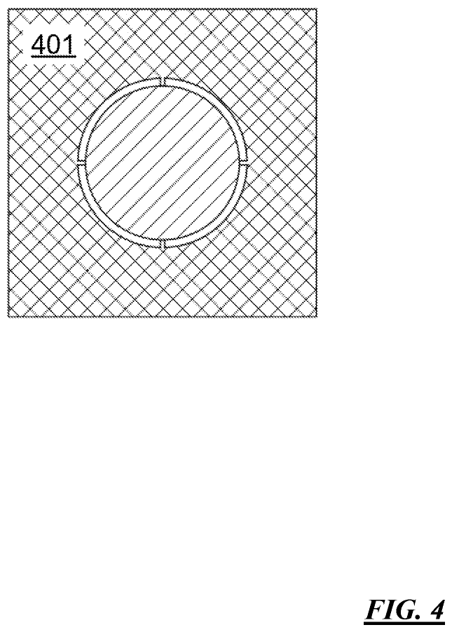

FIG. 4 depicts a top-down cross section of a different metal sheet. The metal sheet may include a support structure 401. Within the support structure 401, several small voids may be cut into the sheet to distribute void space throughout the support structure 401. A workpiece assembled from any number of sheets depicted in FIG. 4 with the top and bottom layer comprised of the sheets depicted in FIG. 1 may result in a workpiece containing a support structure, a part, at least one internal channel that is fluidically connected to the exterior, and/or at least one void space that is not fluidically connected to the exterior.

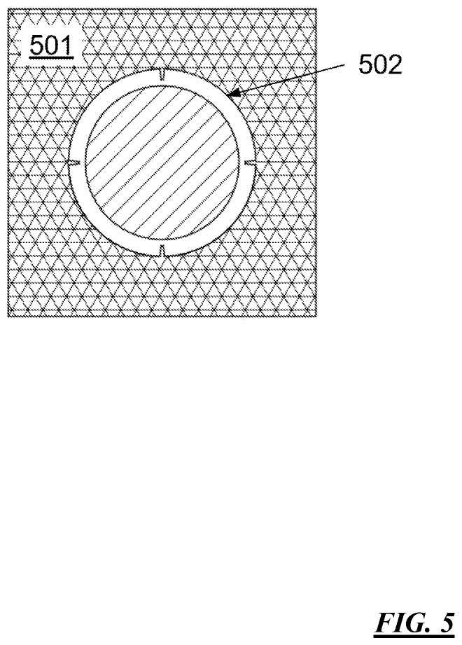

FIG. 5 depicts the metal sheet of FIG. 4 after the metal sheet has been isostatically pressed. As shown, the void spaces may compress, which may reduce the size of the support region 501 and fracture bridging tabs between the support region 501 and the part region 502.

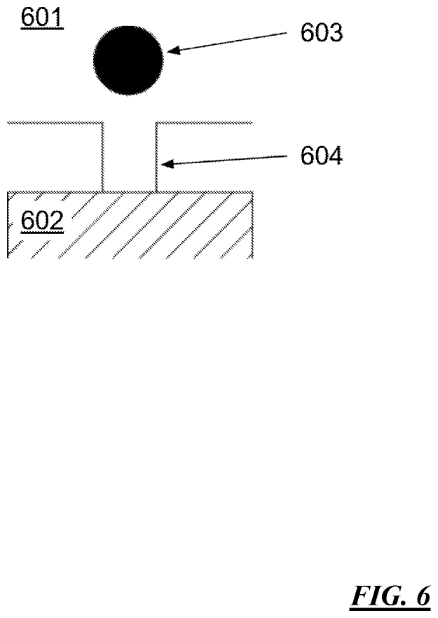

FIG. 6 depicts a side-view cross section of a workpiece before isostatic pressing. The workpiece may be assembled using any of the methods described herein. As shown, the workpiece may include a support 601, a part 602, and a void space 603 with a void space behind a tab 604 before isostatic pressing. The tab 604 may connect the support region to the part region.

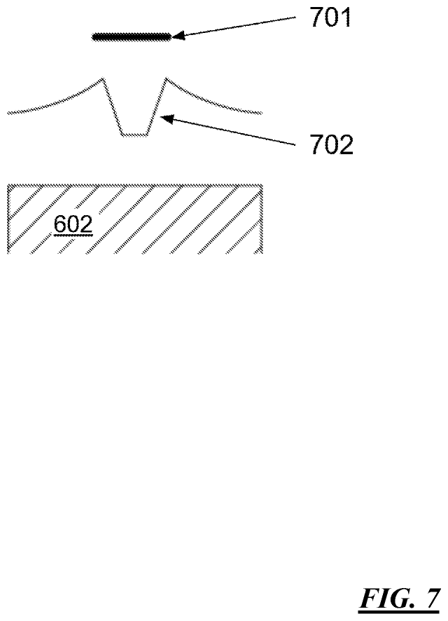

FIG. 7 depicts the workpiece of FIG. 6 after isostatic pressing. The void space (701) may compress, separating the tab (702) from the part (602).

### Support Removal

In some embodiments, a support structure may be removed by placing sufficient void space in the support to shrink the support structure away from the part. For example, a pattern of small voids may be located in a subregion of the support structure to shrink the size of a feature on the support structure. Under isostatic pressing, the support structure may collapse away from the part, enabling the part to be removed without contacting the support structure. An uneven distribution of void space may allow particular features of the support structure to be compressed and removed from close contact to the part.

In some embodiments, additional cuts may be placed in the support structure regions to subdivide the support structure into multiple support pieces. At least some of the subdivided support pieces of the support structure may be configured to have void space. Isostatic pressing may compress the subdivided supports in this support region, enabling the removal of the subdivided supports from the part. In some embodiments, the subdivided support pieces may be of a size that enables the pieces to be tumbled and/or otherwise removed from a partially enclosed volume of the part.

In some embodiments, the subdivided support pieces may remain partially connected to other subdivided support pieces via tabs, flexures, and/or other connection points. These connections may allow the support to be connected in a linear fashion so that the subdivided pieces may be pulled sequentially through a smaller aperture in the part, removing the support from a partial enclosure and/or from a region where the part overhangs the support. The geometry of the part may partially and/or completely surround the subdivided support except for the aforementioned aperture. Additionally and/or alternatively, the subdivided support structure may consist of small, tessellated pieces, which can be shaken out of the partial enclosure. The subdivided support pieces may be smaller than an aperture on the part either with or without isostatic pressing.

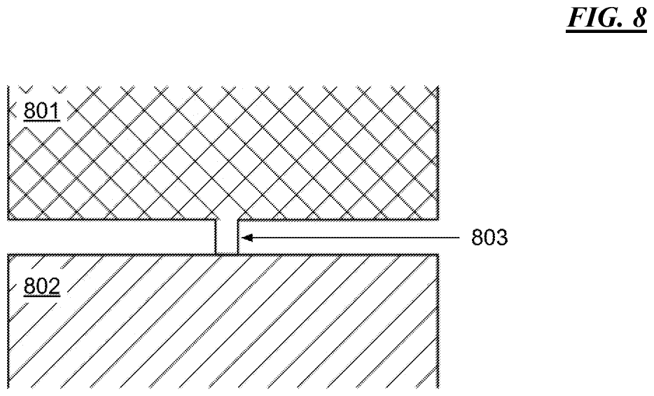

FIG. 8 depicts a side-view cross section of another workpiece before isostatic pressing. The workpiece may include a support structure 801 with distributed void space connected to a part 802 with bridging tabs 803 before isostatic pressing.

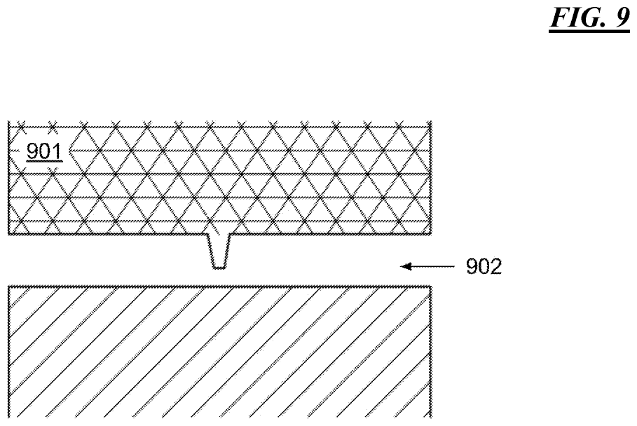

FIG. 9 depicts the workpiece of FIG. 8 after isostatic pressing. Isostatic pressing may compress various microvoids and/or microscopic voids in the support structure 901, shrinking the geometric volume of the support structure 901. The support structure 901 may move away from the part surface, breaking various tabs between the support structure 901 and the part 902.

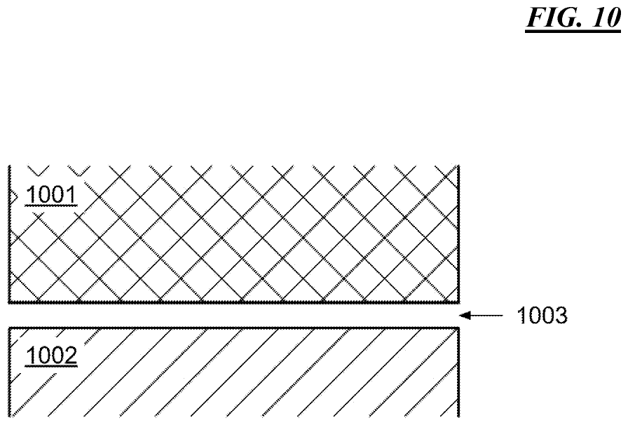

FIG. 10 depicts a side-view cross section of yet another workpiece before isostatic pressing. The workpiece may include a support structure 1001 and a part 1002 separated by a small-width gap 1003 between the support structure 1001 and the part 1002. The support structure 1001 may include a distribution of voids that enables support shrinking as described herein (e.g., in FIGS. 8 and 9).

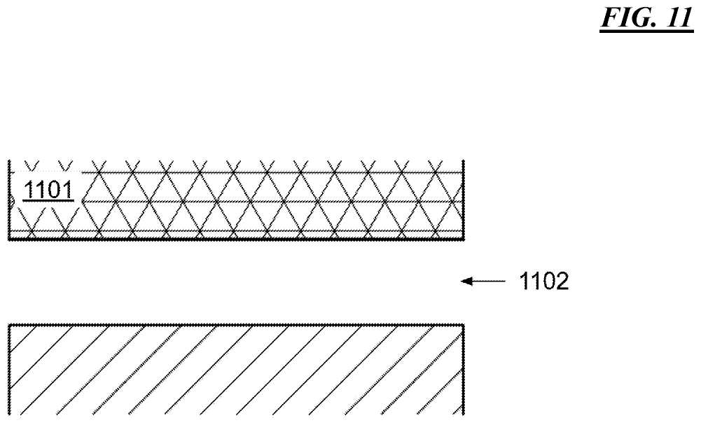

FIG. 11 depicts the workpiece of FIG. 10 after isostatic pressing. Under isostatic pressing, the support structure 1101 may compress and reduce in volume. The small-width gap between the support structure 1101 and the part may be widened 1102 as the support structure 1101 moves away from the part.

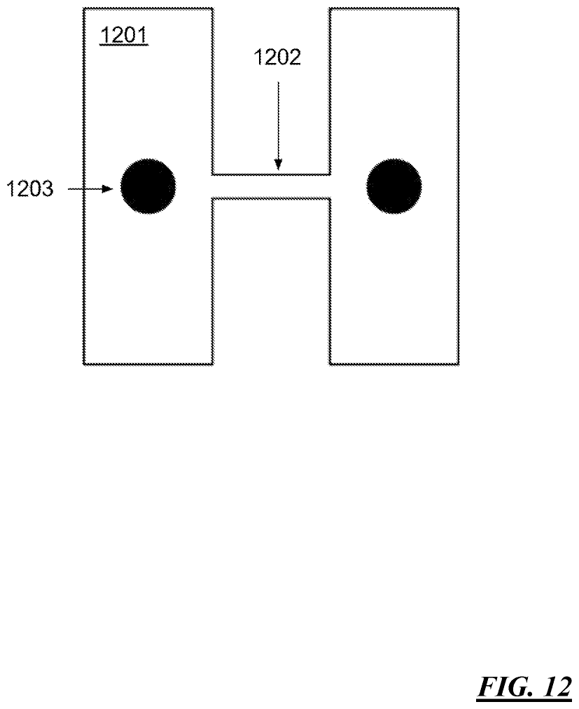

FIG. 12 depicts a side-view cross section of still another workpiece before isostatic pressing. The workpiece may include two support structures 1201 with one bridging tab 1202 that connects the support structures 1201. Void space 1203 may be located in the support structures 1201 behind the bridging tab 1202.

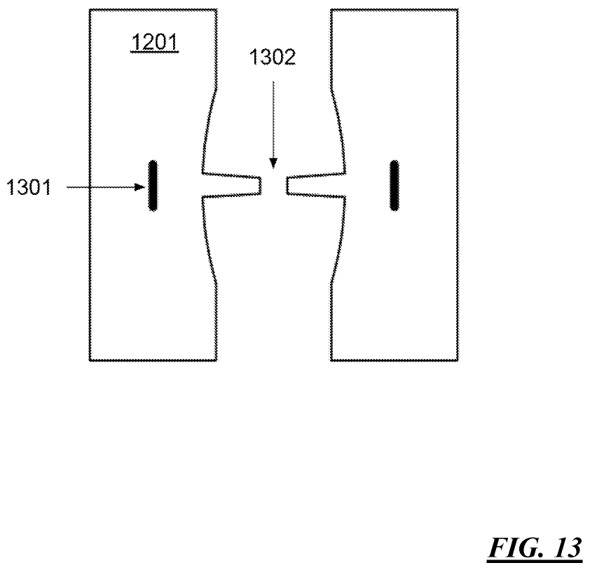

FIG. 13 depicts the workpiece of FIG. 12 after isostatic pressing. Under isostatic pressing, the void spaces 1301 may compress and as a result fracture the bridging tab 1302. The support structures 1201 may compress in volume, causing subregions of the support structures 1201 to move away from one other.

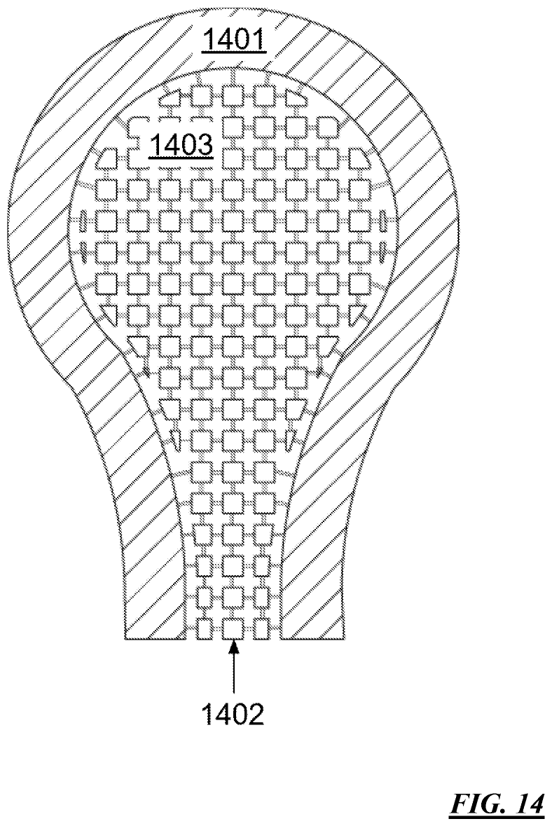

FIG. 14 depicts a side-view cross section of a part. The part 1401 may include a small aperture 1402 that encloses some volume intended to be empty in a final version of the part 1401. A support structure consisting of several support regions connected by bridging tabs may fill the enclosed volume 1403. Under isostatic pressing, the support structure may compress and fracture into several pieces via any of the methods described herein, such as the method described in FIGS. 12 and 13. The fragments of the support structure may be smaller in at least one dimension than that of the aperture (1402).

### Part Manipulation

In some embodiments, a pattern of void space may be configured in a part region to form at least one fold line and/or fold curve. Under isostatic pressing, the void space may collapse and the part may be folded and/or otherwise formed into a shape with a different geometry than in the intermediate state contained within the workpiece.

More complex part folding geometries may be accomplished by configuring part regions with multiple fold lines and/or fold curves. Developable curved surfaces may be accomplished by placing a series of fold lines in at least one axial direction.

In some embodiments, the pattern may enable folding in at least one axial direction, in a combination of two axial directions, and/or a combination of all three axial directions.

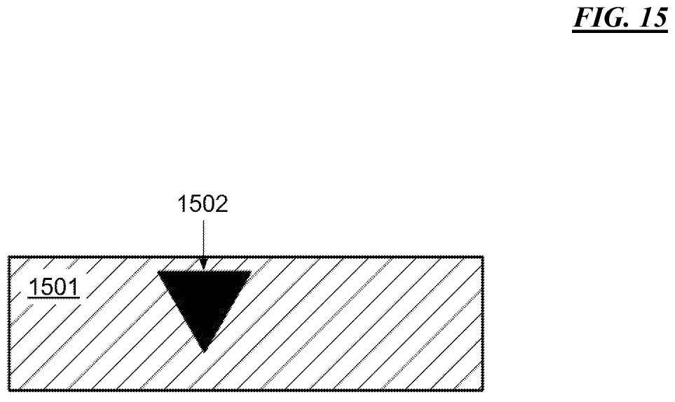

FIG. 15 depicts a side-view cross section of a part before isostatic pressing. The part 1501 may include a shaped void space 1502 interior to the part 1501. As shown, for example, the shaped void space 1502 may have a triangular geometry within the side-view cross section.

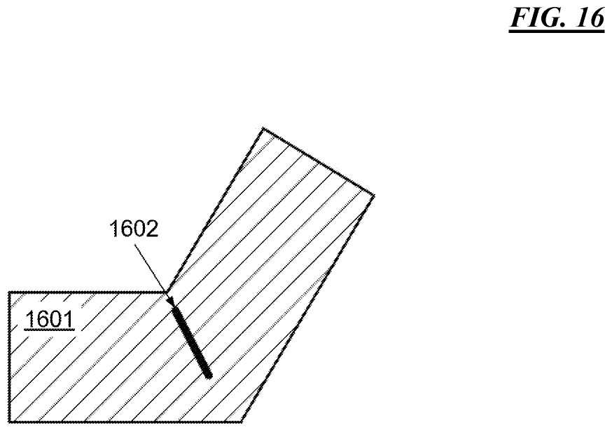

FIG. 16 depicts the part of FIG. 15 after isostatic pressing. Under isostatic pressing, the void space 1602 may collapse and some fraction of the part 1601 may be formed into a different geometry. As shown, for example, some fraction of the part 1601 may fold into a rectilinear geometry.

### Equivalents

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

1. A method for manufacturing an object, the method comprising:
depositing material sequentially to form a workpiece, the material configured to comprise at least one part region, at least one support structure region, and at least one collapsible void space; and
isostatically pressing the workpiece to collapse the collapsible void space wherein the collapsible void space is fluidically isolated.

2-3. (canceled)

4. The method of claim 1 wherein collapsing the collapsible void space separates at least one part region from at least one support structure region.

5. The method of claim 1 wherein collapsing the collapsible void space separates at least one support structure region from at least one other support structure region.

6. (canceled)

7. The method of claim 1 wherein the collapsible void space is configured in a part region to form at least one of a fold line and fold curve, such that collapsing the collapsible void space changes the geometry of the workpiece.

8. (canceled)

9. The method of claim 8, wherein the collapsible void space is configured in a way that reduces the size of at least one of the part region and the support structure region to less than the size of an aperture on an enclosure formed by at least one of the complementary regions.

10. (canceled)

11. The method of claim 2, wherein the collapsible void space is configured to have an aspect ratio greater than 1 and the long dimension of the collapsible void space is parallel to an axis of force applied to the workpiece.

12. The method of claim 2, wherein the collapsible void space has a cross-sectional geometry that is rectilinear, triangular circular, or ellipsoid.

13-14. (canceled)

15. A system for additive manufacturing of an object, the system comprising:
an additive manufacturing device configured to deposit material sequentially to form a workpiece, the material configured to comprise at least one part region, at least one support structure region, and a collapsible void space; and
a pressor configured to isostatically press the workpiece to collapse the collapsible void space.
wherein the collapsible void space is fluidically isolated.

16-18. (canceled)

19. The system of claim 15, wherein at least one part region is connected to at least one support structure region.

20. The system of claim 15, wherein the pressor is configured to:
submerge the workpiece in a fluid; and
apply pressure to the workpiece and the fluid.
